(19) United States
(12) Patent Application Publication
(10) Pub. No.: US 2008/0031506 A1
(43) Pub. Date: Feb. 7, 2008

(54) Texture analysis for mammography computer aided diagnosis

(76) Inventors: Anuradha Agatheeswaran, San Jose, CA (US); Daoxian H. Zhang, Los Gatos, CA (US); Yang Zheng, San Jose, CA (US)

Correspondence Address: Carestream Health Inc,, 150 Verona Street, Rochester, NY, 14608, US

(21) Appl. No.: 11/500,183

(22) Filed: Aug. 7, 2006

(51) Int. Cl. G06K 9/00

(52) U.S. Cl. 382/132

(57) ABSTRACT

A method of characterizing a mass within a digital mammogram. A region of interest is identified that includes the mass and surrounding tissue. A border outline of the mass is identified. A rectangular image is formed wherein each column of the image is formed by repetition of steps. A vector is employed for each of a set of ray angles, wherein the vector extends from a central point of the mass and intersects the border outline at an intersection point. A starting pixel along the vector is identified, between the intersection point and the central point, at a first distance before the intersection point. An ending pixel along the vector is identified at a second distance beyond the intersection point. Pixels along the vector, from the starting pixel to the ending pixel, are remapped as the respective column in the rectangular image. Texture features are extracted from the formed rectangular image.

### FIELD OF THE INVENTION

This invention generally relates to medical image analysis and more particularly relates to an automated method for obtaining texture information for imaged tissue.

### BACKGROUND OF THE INVENTION

The benefits of computer-aided diagnosis in radiology in general, and particularly in mammography, have been recognized. To date, there has been considerable effort directed toward computer-aided methods that assist the diagnostician to correctly and efficiently identify problem areas detected in a mammography image and to improve the accuracy with which diagnoses are made using this information.

Functions of computer-aided diagnosis include detection of mass structures within imaged tissue and characterization of their features. In general, it has been observed that sharply defined masses that have somewhat “regular” shapes are rarely malignant, while more irregularly shaped masses are of higher concern. Salient examples of irregularly shaped masses include highly spiculate masses, often termed “spiculated” masses in the mammography imaging literature. Characterized by multiple slender radiating extensions or “spikes” or as “stellar patterns”, spiculated mass structures can be strong indicators of malignancy.

Accurate detection and classification of spiculated masses, including differentiating suspicious spiculate structures from normal structures having some of the same shape characteristics, presents a challenge to Computer-Aided Diagnostic (CAD) systems. Typically, algorithms for processing digital mammograms begin by locating masses according to tissue density. Then, once a mass of interest has been identified, shape characteristics such as degree of spiculation can be obtained. However, it has been observed that conventional image processing techniques employed by CAD systems can fail to detect masses that are small, but have considerable spiculation and are, therefore, indicative of malignancy in early stages.

In acknowledgement of this difficulty, various approaches for more accurate detection and assessment of spiculate structures have been proposed. For example, U.S. Pat. No. 6,301,378 (Karssemeijer et al.) entitled “Method and Apparatus for Automated Detection of Masses in Digital Mammograms”, describes algorithmic methods for direct detection of spiculated mass structures, with or without a central mass, using gradient image data.

A tool considered for mammographic detection and classification is texture analysis. As is described, for example, in U.S. Patent Published Application No. 2004/0190763 (Giger et al.) entitled “Automated Method and System for Advanced Non-parametric Classification of Medical Images and Lesions”, texture analysis utilizes image gradient data to quantify patterns in mass shapes that are not easily discernable from surrounding tissue. In a paper entitled “Computerized Characterization of Masses on Mammograms: The Rubber Band Straightening Transform and Texture Analysis” by B. Sahiner, H. Chan, N. Petrick, M. Helvie, and M. Goodsitt in Medical Physics 25 (4), April, 1998, pp. 516-526, researchers describe algorithmic methods for texture assessment of a spiculated mass and its surrounding tissue. The Sahiner et al. paper describes a method for re-mapping pixels for tissue that borders a spiculated mass into a band having columns corresponding to normals extended from the mass and rows corresponding to distance from edges of the mass. As is described in more detail subsequently, the method given in the Sahiner et al. paper may provide some improvement in classification accuracy; however, this method has some drawbacks that constrain its effectiveness with some types of mass shapes.

In digital mammography, the standard metric for rating the performance of a diagnosis algorithm is termed the Receiver Operating Characteristic, abbreviated ROC. For a test set of proven diagnoses, an ROC curve plots the proportion of true positive detections against false positive detections. The graph of FIG. 11 shows an example ROC curve. The area under the ROC curve, termed A_{z}, is used to represent the relative degree of class separation between true positive and false positive detections. Area A_{z} is normalized and serves as an indicator of the overlap of probability density functions for positive (target) and negative (non-target) detections. For a system or technique that achieves perfect and accurate assessment every time, the area under the ROC curve, A_{z}, would equal 1. A worst-case ROC curve would yield an area A_{z} value of 0.5.

To date, digital mammography has provided a useful tool for assisting the radiologist in early detection and classification of malignancies and can help to improve the overall accuracy of diagnosis based on mammographic images. However, there is room for improvement. Further accuracy, as measured using area Az, can mean earlier detection for some patients and eliminate the need for unnecessary biopsies for others. Thus, there is a need for improved image mass detection and classification techniques, particularly those for assessment of spiculated masses.

### SUMMARY OF THE INVENTION

According to one aspect of the present invention, there is provided a method of characterizing a mass within a digital mammogram comprising: a) identifying a region of interest that includes the mass and at least a portion of surrounding tissue; b) segmenting the mass to identify a border outline; c) forming a rectangular image wherein each column of the image is formed by repeating the following for each of a set of ray angles: along a vector at that ray angle, wherein the vector extends from a central point of the segmented mass and intersects the border outline at an intersection point: (i) identifying a starting pixel along the vector, wherein the starting pixel lies between the intersection point and the central point and wherein the starting pixel lies a first distance before the intersection point, (ii) identifying an ending pixel along the vector, wherein the ending pixel lies a second distance beyond the intersection point, (iii) remapping pixels along the vector, from the starting pixel to the ending pixel, as the respective column in the rectangular image; and d) extracting texture features from the rectangular image formed thereby.

According to another aspect, the present invention provides a method of characterizing a mass within a digital mammogram comprising: a) identifying a region of interest that includes the mass and at least a portion of surrounding tissue; b) scaling the region of interest to a predetermined size, forming a scaled region of interest thereby; c) segmenting the mass within the region of interest to identify a border outline; d) identifying a central point of the mass within the scaled region of interest; e) computing a width dimension according to the perimeter of a circle that is centered at the central point, has a predetermined radius, and fits within the scaled region of interest; f) computing a set having a plurality of ray angles, wherein the number of ray angles in the set corresponds to the computed width dimension; g) forming a rectangular image wherein each column of the image is formed by repeating the following for a plurality of ray angles in the set: along a vector at that ray angle, wherein the vector extends from the central point and intersects the border outline at an intersection point: (i) identifying a starting pixel along the vector, wherein the starting pixel lies between the intersection point and the central point and wherein the starting pixel is a first distance before the intersection point, (ii) identifying an ending pixel along the vector, wherein the ending pixel lies a second distance beyond the intersection point, (iii) remapping pixels along the vector, from the starting pixel to the ending pixel, as the respective column in the rectangular image; and h) extracting texture features from the rectangular image formed thereby.

The present invention provides a rearranged image of pixels near the perimeter of a tissue mass so that the rearranged image can be utilized with texture analysis tools.

An advantage of the present invention is that it can offer a method for assessment of spiculated masses that is relatively straightforward and minimizes over- or under-sampling.

These and other objects, features, and advantages of the present invention will become apparent to those skilled in the art upon a reading of the following detailed description when taken in conjunction with the drawings wherein there is shown and described an illustrative embodiment of the invention.

### BRIEF DESCRIPTION OF THE DRAWINGS

While the specification concludes with claims particularly pointing out and distinctly claiming the subject matter of the present invention, it is believed that the invention will be better understood from the following description when taken in conjunction with the accompanying drawings, wherein:

FIG. 1 is a flow diagram showing the logic sequence for obtaining tissue features according to the present invention.

FIG. 2 is a plan view showing an ROI, its segmentation, and a transformed image according to the present invention.

FIG. 3 is an enlarged view showing normals computed for a segment of a mass when using a conventional texture assessment method.

FIG. 4 shows an example segmented mass and the overall geometry used to locate radial vectors for texture analysis.

FIG. 5 is a schematic diagram showing the mapping of radial vectors in a segmented image to columns in a transformed image according to the present invention.

FIG. 6 is an enlarged view (not to scale) showing how pixels along a radial vector are obtained for a transformed image.

FIG. 7 is a schematic diagram showing the relationship of radial vectors in a segmented image to columns in a transformed image.

FIG. 8 is a table listing GTSD matrix definitions at each of a set of angles within a transformed image.

FIGS. 9A through 9E provide a table that lists calculations used on a gray-tone spatial dependence matrix for texture analysis.

FIGS. 10A and 10B list calculations used for gray-level run-length analysis of a transformed image for texture assessment.

FIG. 11 shows a exemplary ROC curve for a CAD system.

### DETAILED DESCRIPTION OF THE INVENTION

The present description is directed in particular to elements forming part of, or cooperating more directly with, apparatus in accordance with the invention. It is to be understood that elements not specifically shown or described may take various forms well known to those skilled in the art.

The method of the present invention uses hardware and software components, but is independent of any particular component characteristics such as architecture, operating system, or programming language, for example. In general, the type of system equipment that is conventionally employed for scanning, processing, and classification of mammography image data, or of other types of medical image data, is well known and includes at least some type of computer or computer workstation, having a logic processor which may be dedicated solely to the assessment and maintenance of medical images or may be used for other data processing functions in addition to image processing. Typically, results display on a monitor screen or, optionally, results may be printed. Characteristics such as processing speed, memory and storage requirements, networking and access to images, and operator interface, for example, would be suitably selected for the image analysis function and the viewing environment, using practices and guidelines that are well known in the medical image processing arts.

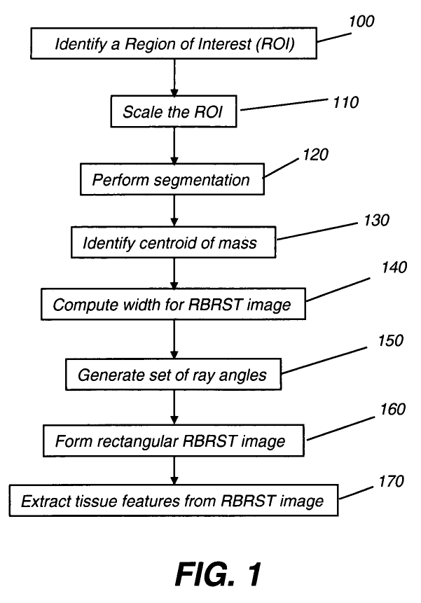

The present invention employs an algorithm for the analysis of texture features from a region of interest that has been identified in a mammogram or other type of diagnostic image. FIG. 1 shows a flow diagram for the processing sequence that provides texture analysis. In an ROI identification step 100, a region of interest (ROI) is identified, where the region of interest includes a tissue mass having characteristics that could indicate malignancy. ROI identification step 100 can be performed by a radiologist or, preferably, using image processing algorithms that use well known techniques that could include density-based bandpass enhancement and peak value extraction, or using edge detection, density thresholds, or wavelet analysis, for example. Masses can be detected using image features such as intensity, iso-intensity, location, and contrast, and employing tools such as template-matching, bilateral subtraction, and other techniques familiar to those skilled in the diagnostic imaging arts.

FIG. 1 provides a flow diagram of the method steps. At step 110, a region of interest (ROI) is identified. At step 110, the ROI is scaled. At step 120, segmentation is performed. At step 130, a centroid of mass is identified. At step 140, a width for the RBST image is computed. At step 150, a set of ray angles is generated. At step 160, a rectangular RBST image is formed. At step 170, tissue features from the RBST image are extracted.

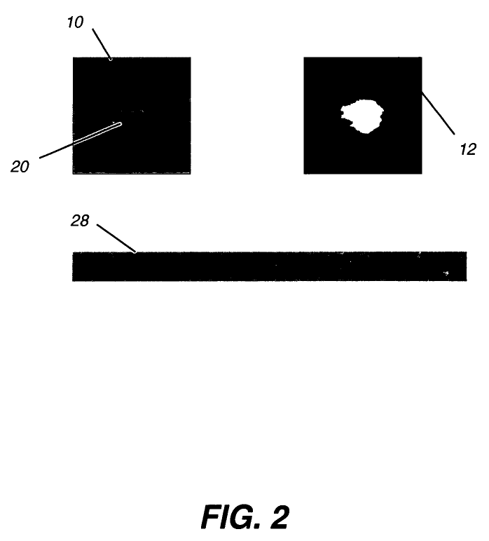

As shown in FIG. 2, the result of ROI identification step 100 is an ROI 10 that includes a mass 20 for texture assessment.

Referring again to FIG. 1, once an ROI is detected, a scaling step 110 follows. In scaling step 110 (optionally, after a coarse segmentation), the ROI is scaled to a predetermined size. For example, in one embodiment, the ROI is scaled to a 256×256 pixel image, based on empirical testing. Scaling to some other dimension could alternately be performed, as well as scaling to a pixel arrangement that is non-square. In addition, the image bit depth may also be adjusted from the original data; for example, in one embodiment, the image data, originally 12 bit, is truncated to provide 8-bit data for texture analysis.

Segmentation is then performed in a segmentation step 120. Segmentation can include operator steps or can be an automated process. Possible segmentation methods include region growing, region smoothing, and discrete contour analysis. As shown in FIG. 2, segmentation defines an outline for mass 20, shown as a mask 12.

The segmented and scaled ROI can now be processed using texture analysis utilities of the present invention that are particularly well adapted to provide texture data for spiculate masses.

In order to better understand the method of the present invention, it is instructive to review a conventional method, described in the Sahiner et al. paper cited in the background, that performs an image transform intended to be used for texture analysis. Using the technique given in the Sahiner et al. paper, pixels along the border of a mass are enumerated, forming an enumeration list that is then used to compute a set of normals to the mass boundary. Pixels lying along each normal, nearby the boundary pixels, are then used to form a column in a rectangular transformed image. Texture analysis utilities can then operate on the transformed image in order to extract spiculate features.

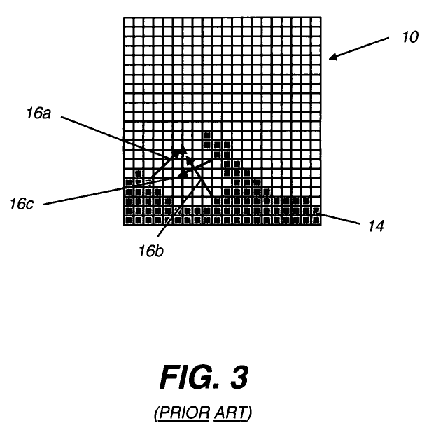

While the method described in the Sahiner et al. paper may offer some advantages, there are drawbacks to this method that can make it complex to use and reduce its effectiveness. For example, constructing normals to the surface requires considerable computation. For each pixel on the boundary, a normal can be approximated using coordinates of some number k of adjacent pixels. If the number k is too small, normals to the surface fall within a small range of angles; if k is too large, other angular anomalies can occur. One problem when using normals relates to curvature that might be highly concave or convex. FIG. 3 shows a portion of one scaled ROI 10 in which boundary pixels 14 define a concave shape. Here, normals 16a, 16b, and 16c all intersect each other, resulting in a oversampling condition. An opposite undersampling condition could also occur with a convex surface, so that areas surrounding the mass within the ROI are effectively skipped. The Rubber Band Straightening Transform (RBST) method described in the Sahiner et al. paper performs best when the segmentation boundary has a more “regular” shape. However, some types of spiculated masses, more likely indicators of cancer than regular shaped masses, do not fall into this category. For these reasons, the effectiveness of this earlier technique may be constrained.

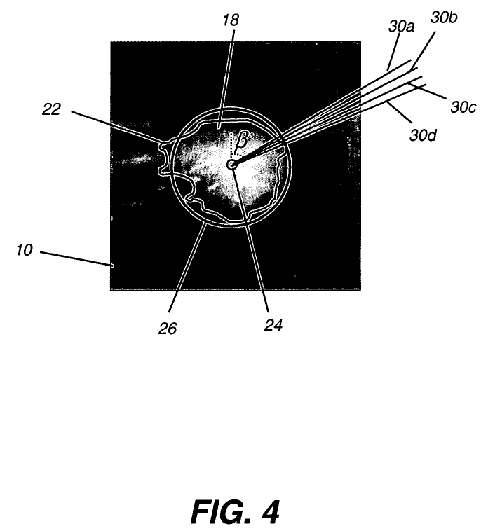

The present invention provides a method to overcome the limitations of earlier techniques for obtaining a transform of pixels bordering a mass. Unlike the Sahiner et al. approach that constructs a normal at each of multiple pixels on the mass surface, the method of the present invention provides a simpler technique using radial vectors for obtaining a transform of tissue areas near a detected mass. FIGS. 4-6 show individual steps in the method of the present invention, which obtains a Rubber Band Radiating Straighten Transform (RBRST) image that offers improved performance over the earlier RBST method.

FIG. 2 shows an RBRST image 28 formed according to the present invention. Subsequent details, following along the flow diagram of FIG. 1, describe each step in obtaining RBRST image 28.

Referring to FIG. 4, there is shown ROI 10 having a segmented mass 18, defined by a border outline 22. A central point 24, such as the centroid or other suitable central point approximately at the middle of ROI 10 is identified in a central point identification step 130 (FIG. 1). By default, central point 24 is the centroid, centered within ROI 10. However, the position of central point 24 may need to be adjusted, as is described subsequently. Central point 24 is used to construct a circle 26 of a predetermined diameter.

In one embodiment, it has been empirically determined that an effective diameter of circle 26 is 128 pixels, half the width of the 256×256 pixel ROI. This effective diameter can be varied depending on detected mass size and ROI size. The size of circle 26 can be adjusted, since this shape is used to simplify computation of the transformed RBRST image.

In a width computation step 140 (shown in FIG. 1), the perimeter of circle 26 is used to compute the final width of RBRST image 28. For example, where circle 26 has diameter 128, the perimeter of circle 26, in pixels and rounded, is simply:

128π=402 pixels

This width value is used to determine the number of radial vectors 30a, 30b, 30c, 30d, . . . 20n that are used in forming RBRST image 28. This computation, which effectively provides a set having a number of ray angles β as shown in FIG. 4, is performed in ray angles generation step 150 (FIG. 1). Only a small number of radial vectors 30a, 30b, 30c, 30d, . . . 30n are shown for the representation of this process in FIG. 4. In practice, radial vectors 30a, 30b, 30c, 30d, . . . 30n would be more densely packed together. As a maximum in the example just given, there could be a maximum of 402 radial vectors in this set; in practice, fewer ray angles could be used.

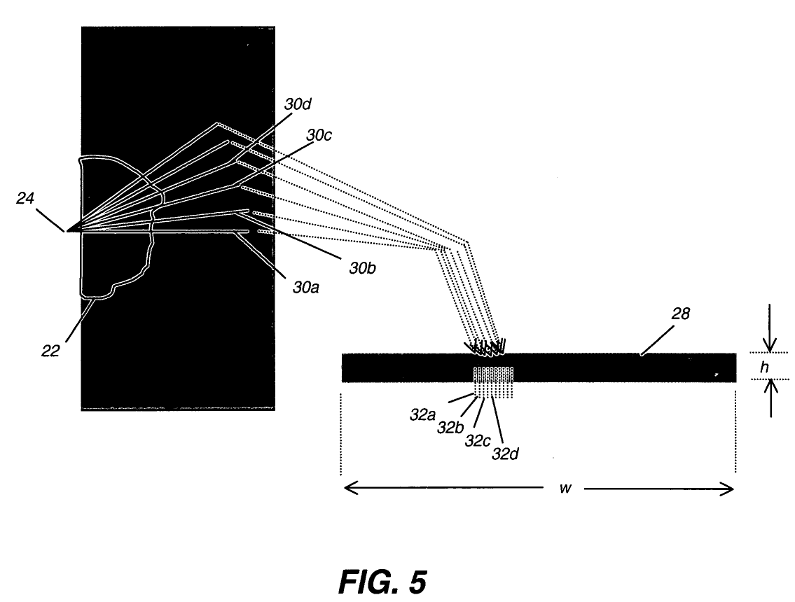

FIG. 5 shows how radial vectors 30a, 30b, 30c, 30d, . . . 30n are used and correspond to columns 32a, 32b, 32c, 32d . . . 32n in RBRST image 28 as part of an RBST image-forming step 160 (FIG. 1). As noted earlier, elements of these figures cannot be drawn to scale. However, the basic relationship between these components can be represented in this way. Width w of RBRST image 28 corresponds to the number of radial vectors used (or, correspondingly, the number of ray angles computed for the mass). Height h of RBRST image 28 corresponds to the number of pixels obtained along each radial vector.

Only a subset of pixels along any radial vector 30a, 30b, 30c, 30d, . . . 30n is used to form the corresponding column 32a, 32b, 32c, 32d . . . 32n in RBRST image 28.

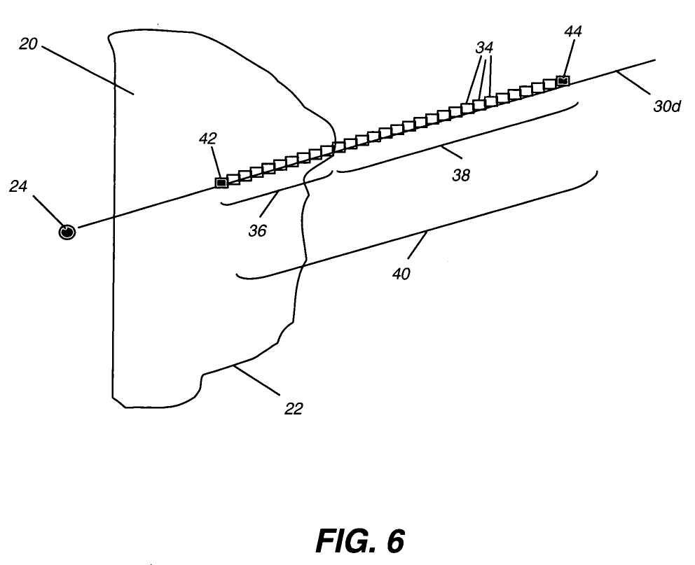

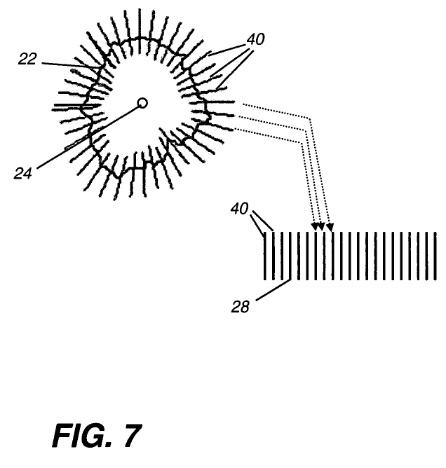

By way of example, FIG. 6 shows how a subset of pixels 34 that are arranged along radial vector 30d are obtained for column 32d in one embodiment. A column segment 40 consists of those pixels 34 that form a column in RBRST image 28. Column segment 40 has two sections: (i) an inner portion 36 that includes all pixels 34 along radial vector 30d from a starting pixel 42 up to the intersection point of radial vector 30d and border outline 22 of mass 20 and (ii) an outer portion 38 that consists of pixels 34 along radial vector 30d from the intersection point of radial vector 30d and border outline 22 to an ending pixel 44. In the example shown in FIG. 6, starting pixel 42 is 10 pixels within border outline 22 and ending pixel 44 is 20 pixels just outside of border outline 22. In practice, the lengths of inner and outer portions 36 and 38 can be adjusted to suitable values. As is represented schematically in FIG. 7, multiple column segments 40 are re-mapped to form columns in RBRST image 28.

### Features Extraction for Texture Analysis

Referring again to FIG. 1, once the RBRST image is obtained, image processing is used to extract tissue features from this portion of the ROI image in features extraction step 170.

Texture can be defined as the information content in spatial relationship between the pixels in the image. From an image processing perspective, the texture patterns of a breast lesion and its surrounding area indicate its relative abnormality, since malignant masses penetrate and destroy healthy tissues and change the texture of the breast. Intensity variation is one useful tool for texture analysis. Simple statistical measures of intensity variation include standard deviation, variance, kurtosis and moments of the grey-level histogram of the lesion etc. More complex measurements and techniques such as the radial-polar pixel grouping arrangement described in International Publication No. WO 00/05677 entitled “System for Automated Detection of Cancerous Masses in Mammograms” by Shapiro et al. could be used. Other techniques for assessment of texture features, as described in mammography processing literature, can be incorporated to help with classification. Among some tools used for assessing texture features for CAD are Laws texture measures, gray level difference (GLD) matrices, gray tone spatial dependence (GTSD) matrices, and gray level run length (GLRL) matrices.

Laws texture measures are computed by convolving a 2D kernel with the image. The kernels used for Laws texture assessment are obtained by a combination of 1D vectors that represent characteristics of the image such as Level, Edge, Spot, Wave, and Ripple. For five vectors, there are 25 kernels and thus there are 25 convolved images using this method. For each convolved image, a windowing operation is performed to get the Texture Energy Measure (TEM) at each pixel which is followed by normalization. Further features can then be extracted from the TEM.

Using GLD matrix methods, a histogram (vector) of absolute values of the gray level difference of pixel pairs is calculated. The pixel pairs are then separated by a-displacement vector d=(d1, d2), where d1 and d2 are the displacement in row and columns respectively. By varying the displacement vector, the GLD can be calculated for 0°, 45°, 90° and 135° directions. Further features can be extracted from the histogram.

GTSD and GLRL methods and features extracted from them are of particular value in CAD analysis. GTSD matrices, also known as co-occurrence matrices, use a function of the angular relationship and distance between neighboring pixels in the ROI.

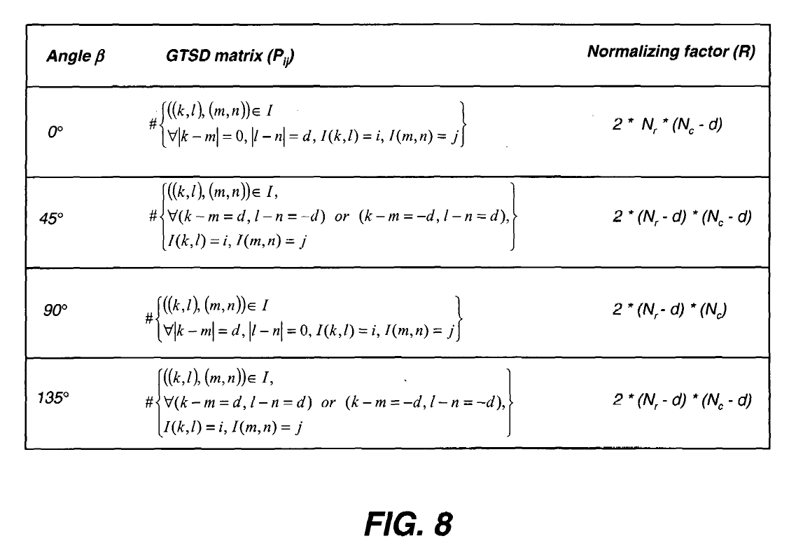

FIG. 8 shows definitions used to identify members of GTSD matrices for each of four angles β. As an example, an ROI image I has Nᵣ rows and N_{c} columns, with N_{g} gray levels. For a given direction θ and distance d, GTSD matrices (Pij) are constructed and texture features are extracted from them. Each entry in the GTSD matrix (Pij) represents the number of occurrences of the pixels with gray levels i and j separated by distance d along the direction θ. For example, if the ROI image is 256×256 and has 8 bit resolution, the GTSD matrix is N_{g}×N_{g} (N_{g}=2⁸). The normalizing factor for GTSD matrix is denoted as R, which is the maximum number of possible pixel pairs in the image I for a given θ and d. The GTSD matrices are calculated for four angles (0°, 45°, 90°, 135°) and d can vary from 1 to 16. In the table of FIG. 8, (k,l) and (m,n) are the neighboring pixels with gray levels i and j respectively at a given θ and inter-pixel distance d.

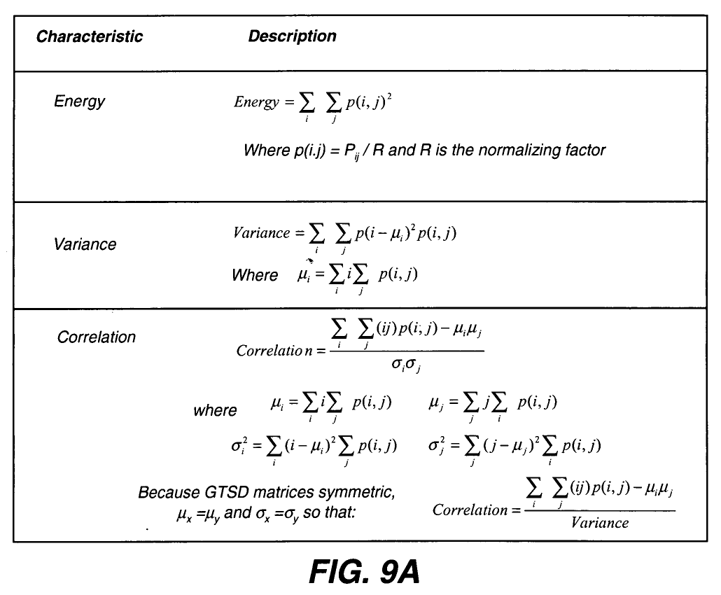

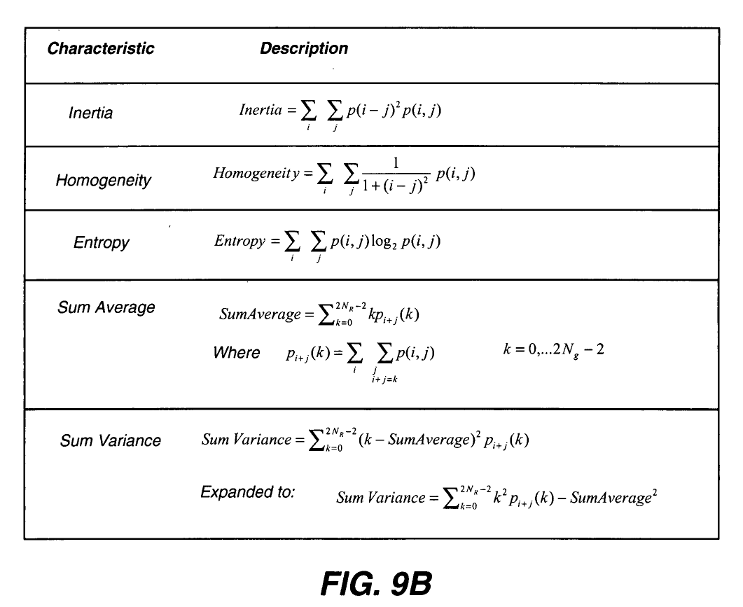

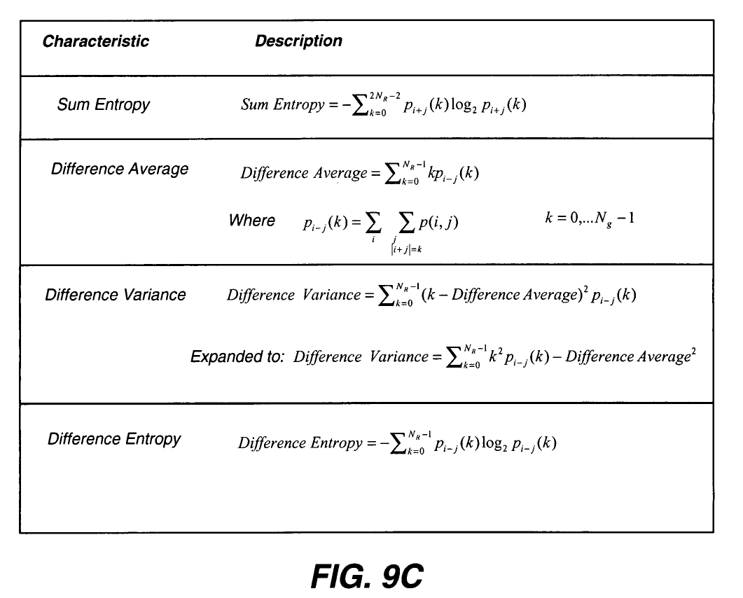

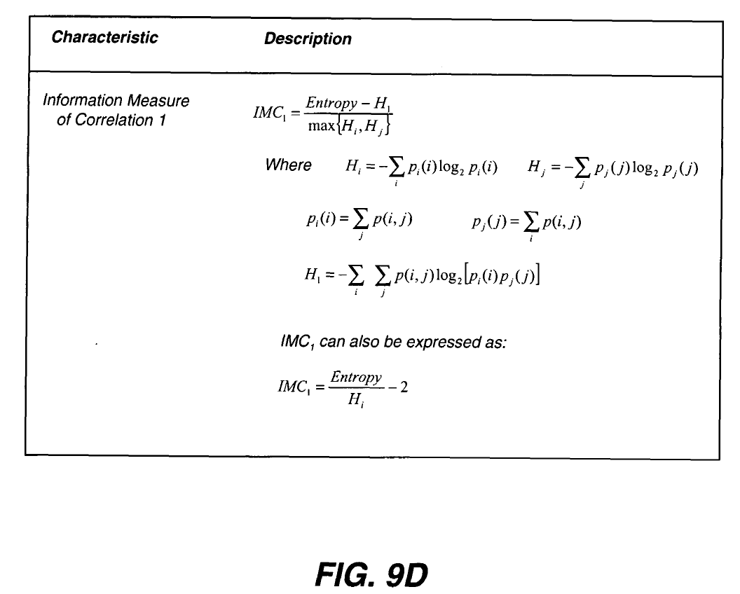

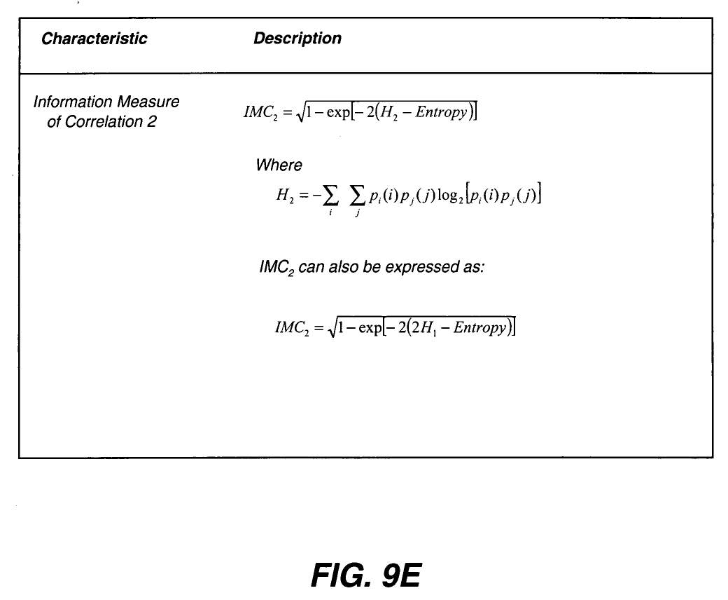

The table in FIG. 9A and continuing in FIGS. 9B, 9C, 9D and 9E, shows texture features extracted from each normalized GTSD matrix. In the previous table of FIG. 8, variables i and j were defined as the gray level values of pixels (k,l) and (m,n). Since rows and columns of the GTSD matrices denote the number of gray level pairs, the variables i and j denote the row and the column index, respectively. GTSD matrices are symmetric, a property that can be used to reduce the total number of computations. Calculations given in FIGS. 9A through 9E can be used directly on the ROI image or, preferably, on the RBRST image to obtain texture features. The value of angle θ can be 0°, 45°, 90°, or 135° and d is the distance between two pixels. Texture characteristics obtained from the RBRST image using this analysis include the following:
Energy—gives a quantifier for overall uniformity within the image.
Variance—gives a measure of distribution of elements.
Correlation—indicates the relative gray tone linear dependence.
Inertia—indicates the measure of degree fluctuations of image intensity, also known as contrast.
Homogeneity—indicates measure similarity. Also known as inverse difference moment.
Entropy—gives a measure of the amount of randomness in the image.
Summed and difference values—various values used in processing, include sum average, sum variance, sum entropy, difference average, difference variance, difference entropy.
Information measure of correlation 1, 2.
Performing GTSD processing for each of these 14 characteristics, at each of 4 angles yields (14*4)=56 values for texture assessment.

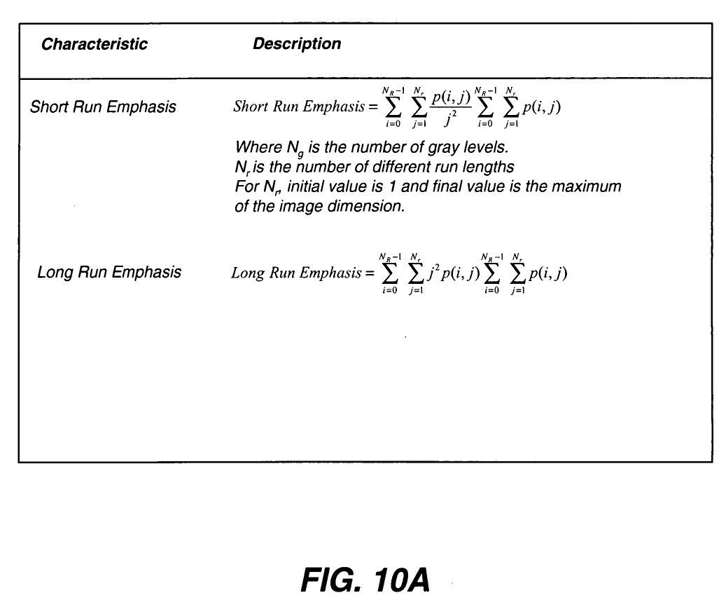

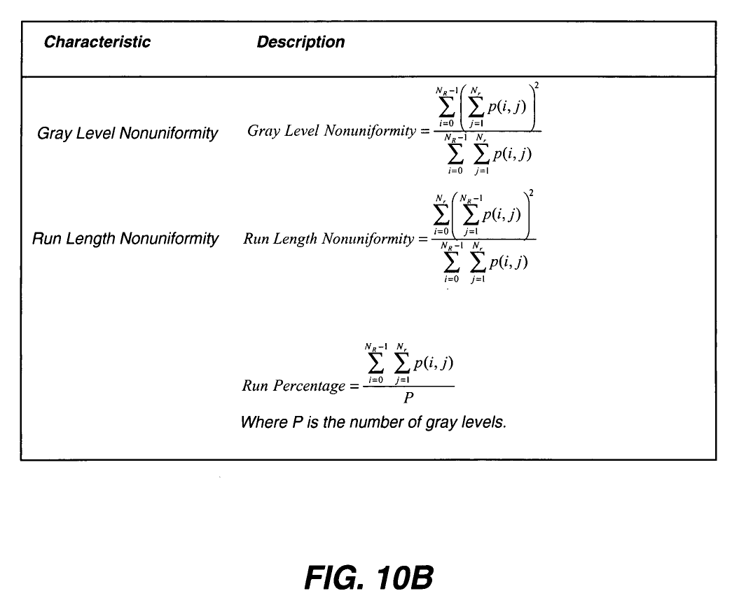

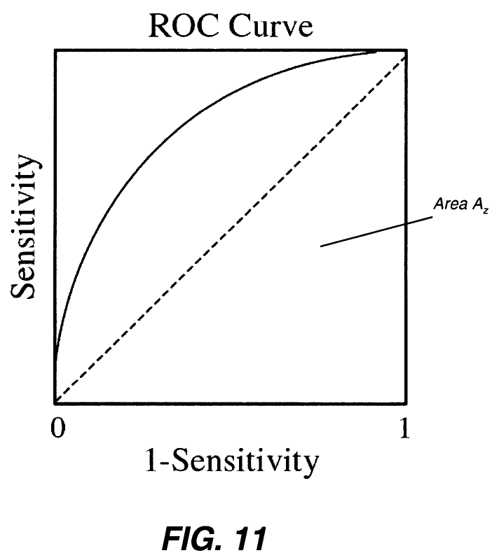

The gray level run is a set of consecutive pixels having the same gray level in a given direction in an image. The GLRL matrices represent the number of gray level runs in an image for a given direction. Like the GTSD matrices, the GLRL matrices are also computed in four directions (that is, at 0°, 45°, 90°, 135°). Where p(i,j) is the (i,j) entry in the GLRL for a given direction, i represents the gray level (or the gray level range) and j represents the number of times the gray level (i) run has occurred in the image being analyzed. Tables in FIGS. 10A and 10B list texture characteristics that are computed from the GLRL matrices for each direction, θ where θ equals 0°, 45°, 90°, or 135°, in the RBRST image. Texture characteristics obtained from the RBRST image using this analysis include the following:
Short Run Emphasis—measures the significance of short runs within a gray level image. A larger value indicates a proportionally larger number of short run segments.
Long Run Emphasis—measures the significance of long runs within a gray level image. A larger value indicates a proportionally larger number of long run segments.
Gray Level Nonuniformity—indicates the total number of runs for a given gray level value N_{g}.
Run Length Nonuniformity—gives the total number of a particular run for a given gray level.
Run Percentage—gives the ratio of the total number of runs to the number of gray levels, P.

Performing GLRL processing to obtain these 5 values at each of these 4 directions θ, image processing yields (5*4)=20 sets of texture data for the RBRST image. Thus, the combined number of texture features that are obtained using the GTSD processing of FIGS. 9A through 9E and the GLRL processing of FIGS. 10A and 10B is 76. Further, the texture features obtained in each angular direction θ can be correlated and data that is obtained in orthogonal directions can be averaged together.

An automated feature selection is performed using a sequential forward search (SFS), with techniques well known in the diagnostic image processing arts. SFS begins with an empty set and adds each feature in sequence, with a cost function variable assigned. In one embodiment, the cost function relates to the A_{z} value or area under the ROC curve, as described earlier in the background section.

Overall, empirical data indicates that combined results from both GTSD and GLRL matrix calculations provide enhanced accuracy over individual results. In general, non-averaged data tends to yield improved accuracy over averaged data.

Individual images may require additional processing in some cases. For example, with an unusually shaped mass it may be determined that central point 24 (FIG. 7) lies outside of the detected mass. For such a case, image analysis software may effect a shift in position of central point 24, away from the center of ROI 10. It is noted that central point 24 is a construct only; its purpose is to identify a central location from which radial vectors extend.

The height h of RBRST image 28 (FIG. 5) is 30 pixels in one embodiment, with 10 pixels within the mass boundary and 20 pixels outside this boundary as described earlier. However, with a particularly small mass, it may not be possible to obtain 10 pixels within the mass boundary. For such a case, other methods for pixel selection can be used. For example, 30 pixels along vector 30a, 30b, 30c, 30d, . . . 30n beginning at central point 24 could simply be used for forming a column of RBRST image 28. At the other extreme, it may not be possible to obtain 20 pixels outside the boundary of a mass and still within ROI 10. For such a case, it may be necessary to reduce the segmentation size of the mass to a value (for example, 20 pixels) within the original ROI. Some portion of the mass may be effectively cropped with this approach. Alternately, a different set of pixels along radial vector 30a, 30b, 30c, 30d, . . . 30n could be selected.

In empirical testing, it has been shown that the method of the present invention provides improved results over earlier texture features assessment as conventionally practiced. As has been noted earlier, improvements in diagnostic accuracy translate to life-saving early detection for many patients, and help to eliminate at least a percentage of unnecessary biopsies.

The invention has been described in detail with particular reference to certain preferred embodiments thereof, but it will be understood that variations and modifications can be effected within the scope of the invention as described above, and as noted in the appended claims, by a person of ordinary skill in the art without departing from the scope of the invention. For example, height h of RBRST image 28 could be adjusted to suit the relative size of the mass within an ROI. An ROI can be scaled to some other suitable size or may be given some non-square shape. Additional image assessment tools could be employed for texture measurement of tissue surrounding a segmented mass.

### PARTS LIST

10 ROI
12 Mask
14 Boundary pixel
16a, 16b, and 16c Normal
18 Segmented mass
20 Mass
22 Border outline
24 Central point
26 Circle
28 RBRST image
30a,30b,30c,30d Radial vector
32a,32b,32c,32d Column
34 Pixel
36 Inner portion
38 Outer portion
40 Column segment
42 Starting pixel
44 Ending pixel
100 ROI identification step
110 Scaling step
120 Segmentation step
130 Central point identification step
140 Width computation step
150 Ray angles generation step
160 RBST image-forming step
170 Features extraction step
β Angle
θ Angle

1. A method of characterizing a mass within a digital mammogram, the method comprising the steps of:
a) identifying a region of interest including the mass and at least a portion of surrounding tissue;
b) segmenting the mass to identify a border outline;
c) forming a rectangular image wherein each column of the rectangular image is formed by repeating the following for each of a set of ray angles:
along a vector at that ray angle, wherein the vector extends from a central point of the segmented mass and intersects the border outline at an intersection point:
(i) identifying a starting pixel along the vector, wherein the starting pixel lies between the intersection point and the central point and wherein the starting pixel lies a first distance before the intersection point,
(ii) identifying an ending pixel along the vector, wherein the ending pixel lies a second distance beyond the intersection point, and
(iii) remapping pixels along the vector, from the starting pixel to the ending pixel, as the respective column in the rectangular image; and
d) extracting texture features from the rectangular image.

2. The method of claim 1 wherein the set of ray angles is formed by the steps of:
computing a width dimension according to the perimeter of a circle that is centered at the central point, has a predetermined radius, and fits within the region of interest; and
computing members of the set of ray angles, wherein the number of ray angles in the set corresponds to the computed width dimension.

3. The method of claim 1 wherein the step of identifying the region of interest comprises a density analysis.

4. The method of claim 1 wherein the step of identifying the region of interest comprises determining the shape of a tissue structure.

5. The method of claim 1 wherein the step of segmenting the mass comprises using region growing algorithms.

6. The method of claim 1 wherein the step of extracting texture features comprises using gray tone spatial dependence analysis.

7. The method of claim 1 wherein the step of extracting texture features comprises using gray level run length analysis.

8. The method of claim 1 wherein the mass is automatically detected from the digital mammogram.

9. The method of claim 1 further comprising the step of scaling the region of interest to form a scaled 256×256 pixel image.

10. A method of characterizing a mass within a digital mammogram, the method comprising the steps of:
a) identifying a region of interest that includes the mass and at least a portion of surrounding tissue;
b) scaling the region of interest to a predetermined size to form a scaled region of interest;
c) segmenting the mass within the region of interest to identify a border outline;
d) identifying a central point of the mass within the scaled region of interest;
e) computing a width dimension according to the perimeter of a circle centered at the central point, has a predetermined radius, and fits within the scaled region of interest;
f) computing a set comprising a plurality of ray angles, wherein the number of ray angles in the set corresponds to the computed width dimension;
g) forming a rectangular image wherein each column of the image is formed by repeating the following for a plurality of ray angles in the set:
along a vector at that ray angle, wherein the vector extends from the central point and intersects the border outline at an intersection point:
(i) identifying a starting pixel along the vector, wherein the starting pixel lies between the intersection point and the central point and wherein the starting pixel is a first distance before the intersection point,
(ii) identifying an ending pixel along the vector, wherein the ending pixel lies a second distance beyond the intersection point, and
(iii) remapping pixels along the vector, from the starting pixel to the ending pixel, as the respective column in the rectangular image; and
h) extracting texture features from the rectangular image formed thereby.

11. The method of claim 10 wherein the step of identifying the region of interest comprises a density analysis.

12. The method of claim 10 wherein the step of identifying the region of interest comprises determining the shape of a tissue structure.

13. The method of claim 10 wherein the step of segmenting the mass comprises using region growing algorithms.

14. The method of claim 10 wherein the step of scaling the region of interest comprises resizing the area of interest to a 256×256 pixel image.

15. The method of claim 10 wherein the step of extracting texture features comprises using gray tone spatial dependence analysis.

16. The method of claim 10 wherein the step of extracting texture features comprises using gray level run length analysis.

17. The method of claim 10 wherein the step of identifying the central point of the mass comprises adjusting the position of the central point away from the center of the region of interest.

18. The method of claim 10 wherein the mass is automatically detected from the digital mammogram.

19. A method of rearranging image data for a portion of a diagnostic image, the method comprising the steps of:
a) identifying the boundaries of a mass in the diagnostic image;
b) locating a centroid within the mass; and
c) obtaining a line of image pixels along each of a plurality of ray angles from the centroid with the following steps for each ray angle:
(i) along a vector extended from the centroid at that ray angle, obtaining spatially sequential pixel values beginning from a starting pixel that is between the centroid and the boundary of the mass, along the vector, and ending at an ending point that is outside of the boundary of the mass with respect to the centroid; and
(ii) remapping the spatially sequential pixel values obtained in (i) into a column of a rearranged image.
